(19) United States
(12) Patent Application Publication
(10) Pub. No.: US 2008/0220034 A1
(43) Pub. Date: Sep. 11, 2008

(54) Antiadhesive Polymers for Prevention of Adhesion of Microorganisms to Textiles and for Prevention of Laundry Odor

(75) Inventors: Dirk Bockmuhl, Wuppertal (DE); Heide-Marie Hohne, Dusseldorf (DE); Noelle Wrubbel, Dusseldorf (DE); Dorothee Heidemeter, Dusseldorf (DE); Doris Dahlmann, Dusseldorf (DE); Thomas Plantenberg, Mettmann (DE); Hermann Jonke, Dusseldorf (DE); Rolf Bayersdorfer, Hamburg (DE); Andre Schafer, Monheim (DE); Roland Breves, Mettman (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/813,430

(22) PCT Filed: Jan. 13, 2006
(86) PCT No.: PCT/EP2006/000255

§ 371 Date: Nov. 8, 2007

(30) Foreign Application Priority Data
Jan. 21, 2005 (DE) 10 2005 003 122.6

(51) Int. Cl. A01N 25/00; A01N 33/00; A01N 31/00

(52) U.S. Cl. 424/404; 424/78.08; 424/78.37; 424/78.17; 424/408

(57) ABSTRACT

Textile treatment agents and/or capsules comprising a polymer having antiadhesive action against microorganisms which adhere to a textile substrate, methods of treating textile substrates therewith and the textile so treated, wherein the polymer comprises a polymeric structural element selected from the group consisting of polyesters, polysaccharides, polyethers, polyurethanes, polyureas, polyamides, and heteropolymers thereof.

The present invention concerns the use of polymers with antiadhesive action against microorganisms to prevent adhesion of microorganisms to textiles and to prevent laundry odor, as well as capsules, washing agents and textile treatments that contain these antiadhesive polymers.

Textiles often have unpleasant odors when items of clothing are worn, or even after laundering. These are caused by skin bacteria that are not adequately removed by use of liquid washing agents. Degradation of skin fats or other residues on the laundry by these bacteria results in bad-smelling compounds that are generally perceived as unpleasant.

Other microorganisms, too, are often not adequately removed when the laundry is washed, especially at low temperatures. Those may include pathogens such as Candida or dermatophytes.

It has now been discovered, surprisingly, that reduction of the adhesion of microorganisms to the laundry, or better separation of microorganisms that have already adhered to the laundry, can be attained by certain polymers.

Use of the specified polymers can reduce, and, preferably, completely prevent unpleasant odors, especially those that occur after washing. In contrast to the odor-absorbing additives described at the state of the art, this invention attacks the cause of the bad odors is attacked, rather than just encapsulating the bad-smelling substances.

With use of antiadhesive substances, application of antibacterially active substances can be omitted, so that the laundry can be treated gently and the problem of resistance development is avoided.

The polymers used have further, preferably additional, desired properties. For example, they can make the textile hydrophilic.

Therefore a first subject of the present intention is use of polymers which have antiadhesive action against microorganisms to prevent adhesion of microorganisms to textiles or laundry. The textiles can be any kind of textile. Examples include textiles of wool, cotton, silk, angora, rayon, polyester, polyamide, polyacrylic, or mixed textiles of those materials.

The microorganisms for which adhesion can be prevented are, according to the invention, especially bacteria, fungi, viruses and algae. That includes bacterial endospore or exospores, and spores that act as propagation structures for fungi. In a preferred embodiment, bacteria and fungi are understood to be microorganisms.

According to the invention, bacteria are considered to be Gram-negative and Gram-positive bacteria, especially bacteria selected from Propionibacterium acnes, Staphylococcus aureus, Group A Streptococci (beta-hemolytic Streptococci), S. pyogenes, Corynebacterium spp. (especially C. tenuis, C. diphtheria, C. minutissimum), Micrococcus spp. (especially M. sedentarius), Bacillus anthracis, Neisseria meningitides, N. gonorrhoeae, Pseudomonas aeruginosa, P. pseudomallei, Borrelia burgdorferi, Treponema pallidum, Mycobacterium tuberculosis, Mycobacterium spp., Escherichia coli and Streptococcus spp. (especially S. gordonii, S. mutans), Actinomyces species (especially A. naeslundii), Salmonella species, Actinobacteria (especially Brachybacterium species), alpha-Proteobacteria (especially Agrobacterium species), beta-Proteobacteria (especially Nitrosomonas species), Aquabacterium species, Hydrogenophaga, gamma-Proteobacteria, Stenotrophomonas species, Xanthomonas species (campestris), Neisseria species, Hemophilus species and all the microorganisms described by Paster et al. (J. Bac. 183 (2001) 12, 3770-3783).

In one particularly preferred embodiment of the invention, the bacteria are selected from odor-producing bacteria, including but not limited to from odor-producing staphylococci, especially from S. hominis, S. epidermidis or S. aureus and/or Gram-positive anaerobic cocci, especially from peptostreptococci, particularly Anaerococcus octavius, and/or from odor-producing corynebacteria, particularly Corynebacterium amycolatum and/or from odor-producing micrococci, especially from members of the genera Micrococcus and Kocuria and/or from odor-producing bacteria of the genera Pseudomonas, Xanthomonas or Stenotrophomonas and/or from odor-producing bacteria of the genus Bacillus.

Therefore a further subject of the current invention is use of polymers with antiadhesive action against microorganisms to reduce laundry odor.

Fungi especially preferred according to the invention are yeasts, molds, dermatophytes and keratinophilic fungi. In relation to the invention, yeasts are single-celled fungi that propagate predominantly by budding. Yeasts are not an independent taxonomic category in the system of fungi. Systematically, most yeasts are classified in the endomycetes. However, budding stages also occur in the developmental cycle of various other fungi, or under certain environmental conditions. Those are called yeast stages. Such single-celled, yeast-like budding growth forms occur in the ascomycetes as well as in the Zygomycetes, Basidomycetes and Deuteromycetes. For the purpose of the invention, all these growth forms are understood to be yeasts.

According to the invention, the fungi are preferably fungi that are pathogenic for humans, especially the human pathogenic species of the classes Ascomycota, Basidiomycota, Deuteromycota and Zygomycota. In particular, they can include the human pathogenic forms of Candida.

Especially preferably, the adhesion of the medically relevant forms of Candida is reduced, for example, that of C. albicans, C. boidinii, C. catenulata, C. ciferii, C. dublinensis, C. glabrata, C. guillermondii C. haemulonii, C. kefyr, C. krusei, C. lipotytica, C. lusitaniae, C. norvegensis, C. parapsilosis, C. pulcherrima, C. rugosa, C. tropicalis, C. utilis, and C. viswanathii. C. albicans, C. stellatoidea, C. tropicalis, C. glabrata and C. parapsilosis are especially preferred.

According to a further preferred embodiment, the adhesion of fungi of the species Rhodotorula spp., Cryptococcus spp., Exophilia spp., and Hormoconis spp. is reduced.

According to the present invention, molds are understood to be those fungi that live in the soil, on foods or fodders, or in concentrated nutrient solutions, develop a typical mycelium, and get their nutrients from organic substances which they degrade (saprobiotic or saprophytic life). Furthermore, they reproduce asexually by spores (especially sporangiospores or conidia), and develop only very small sexual propagation organs, if any.

Also with respect to molds, species from the classes Ascomycota, Basidiomycota, Deuteromycota and Zygomycota must be mentioned as examples, especially all the species of the genera Aspergillus, Penicillium, Cladosporium and Mucor, as well as Stachybotrys, Phoma, Alternaria, Aureobasidium, Ulocladium, Epicoccum, Stemphyllium, Paecilomyces, Trichoderma, Scopulariopsis, Wallemia, Botrytis, Verticillum and Chaetonium.

The Ascomycota include here in particular all species of the genera Aspergillus, Penicillium and Cladosporium. These fungi form spores that exhibit severe allergenic potential on contact with the skin or respiratory tract. Cryptococcus neoforms in particular must be included in the Basidomycota. The Deuteromycota include, as molds, all the known genera, especially those not assigned to the classes Ascomycota, Basidiomycota or Zygomycota because of the absence of a sexual stage.

The keratinophilic fungi are understood to be those skin and/or hair fungi that grow in cornified skin and its appendages (especially hairs and/or nails). In particular, they are understood to include dermatophytes and all the species of the genus Malassezia. Dermatophytes are understood, according to the invention, to be in particular all the species of the genera Trichophyton, Microsporum and Epidermophyton.

The keratophilic fungus Malassezia, a yeast, is considered to be the cause of excessive scaling of the skin, for instance, on the head (dandruff). this organism is also considered to be the initiator of the skin disease Pityriasis versicolor. Therefore it is of particular advantage to reduce or essentially prevent adhesion of Malassezia, particularly that of the species M. furfur (also known as Pityrosporum ovale), M. pachydermatis, M. sympodialis and/or M. globosa.

According to one preferred embodiment, the keratinophilic fungi are selected from Trichophyton mentagrophytes, T. rubrum, T. asteroides, T. concentrium, T. equinum, T. meginii, T. gallinae, T. tonsurans, T. schoenleinii, T. terrestre, T. verrucosum, T. violaceum, Microsporum canis, Microsporum audounii, M. gypseum, Epidermophyton flossocum, Malassezia furfur, M. sympodialis, M. globosa and M. pachydermatis.

According to the invention, the dermatophytes are understood to be, in particular, Trichophyton mentagrophytes, T. rubrum, T. asteroids, T. concentrium, T. equinum, T. meginii, T. gallinae, T. tonsurans, T. schoenleinii, T. terrestre, T. verrucosum, T. violaceum, Microsporum Canis, Microsporum audounii, M. gypseum and Epidermophyton flossocum.

In a preferred embodiment, the reduction of adhesion, with respect to all the microorganisms on a textile, amounts to preferably at least 30%, especially preferably at least 40 or 50%, particularly at least 60 or 70%, and primarily at least 80 or 90%, in comparison with a treatment using a preparation containing the same components other than the polymer having antiadhesive action against at least microorganisms.

In a further preferred embodiment, the reduction of adhesion, with respect to at least one microorganism, especially with respect to at least one bacterium relevant for laundry odor, is preferably at least 30%, especially preferably at least 40 or 50%, particularly at least 60 or 70%, and primarily at least 80 or 90%, in comparison with a treatment using a preparation containing the same components other than the polymer having antiadhesive action against at least microorganisms.

The polymers with antiadhesive action against microorganisms include preferably those having as the structural element a polymer and/or a copolymer with a chain structure from the range of polyesters, polysaccharides, polyethers, polyurethanes, polyureas, polyamides and/or mixed polymers thereof, preferably having a molecular weight of about 100 to about 50,000, especially from about 600 to about 35,000, preferably from about 1,000 to 20,000, and especially preferably from 5,000 to 13,000 g/mole. The molecular weight statements indicate the average molecular weights of the compounds.

Preferred polymers here are water-soluble polyalkylene glycols, especially polyethylene glycols or copolymers of ethylene glycol and propylene glycol with the molecular weights specified above. Mixed copolymers (e.g., Jeffamine, Huntsman) and block copolymers (e.g., Pluronic, BASE) may also be considered as copolymers of ethylene glycol and propylene glycol. Here polyethylene glycol is understood to be not only polyaddition products of ethylene oxide to water or ethylene glycol as the starting molecule, but also polyadditions to other bifunctional alcohols, such as butanediol, hexanediol, or 4,4′-dihydroxy-diphenylpropane. That applies correspondingly for the other polyalkylene glycols. The polymers with antiadhesive action are preferably soluble to at least 0.5 g, especially preferably to at least 1 g, and primarily to at least 5 g in 100 g water at 20° C., and remain dissolved for at least 6 months at 20° C.

The polymers can in particularly be grafted polymers or polyurethanes containing the structural elements previously specified.

Graft Copolymers

The grafted copolymers can in particular be grafted polymers such as are described in the patent applications DE 10157485 and WO99/28404.

In the graft copolymers, the previously specified polymeric structural elements are preferably contained in the graft basis, so that in a preferred embodiment they comprise those essentially or exclusively. Therefore preferably polymers and/or copolymers having a chain structure from the range of polyesters, polysaccharides, polyethers, polyurethanes, polyureas, polyamides, and/or their mixed polymers, having a molecular weight of about 100 to about 50,000, especially about 600 to about 35,000, preferably about 1,000 to 20,000, especially preferably from 5,000 to 13,000 g/mole can be considered as graft bases. We further refer to the disclosures in WO 96/37566 with respect to polymers suitable as graft bases. Polyalkylene glycols are suitable as the graft basis for producing preferred graft copolymers, especially polyethylene glycols or copolymers of ethylene glycol and propylene glycol, which can have either a mixed or a blocked arrangement, with the molecular weights stated above. Mixtures of the polymers stated above can also be used as the graft base, especially the previously mentioned polyalkylene glycols.

Basically all of the previously cited polymeric structural elements graftable compounds with at least one olefinically unsaturated double bond can be used to produce the graft branches. Examples of compounds that can be considered are acrylic acid and methacrylic acid, acrylates and methacrylates of monofunctional alcohols with up to 6 C atoms, acrylonitrile, methacrylonitrile, acrylamide, methacrylamide, 2-acrylamido-2-methylpropanesulfonic acid (AMPS), polyethylene glycol methyl ether methacrylate, 3-trimethylammonium propylmethacryamide chloride (MAPTAC), N-vinylpyrrolidone and N-vinylcarbazole or mixtures thereof. However, esters of an unsaturated C₂₋₆ alcohol, especially of a C₂₋₆ enol, primarily of vinyl alcohol, with linear or branched saturated monocarboxylic acids having 2 to 24 C atoms, especially with 2 to 18 C atoms, primarily 2 to 4 C atoms are used preferably to make the graft branches. With respect to the graft branches, see also the disclosure of WO 96/37566.

The ratio of percentage by weight between the graft base and the graft branches is preferably between 1:199 and 199.1. The ratio of graft base to graft branches is preferably selected so that the graft copolymers are water-soluble, with the water solubility at 20° C. being at least about 1 g/liter, but preferably at least 2, 5 or 10 g/l. The specially preferred ratio of weight percent between the graft base and graft branches is between 50:50 and 199:1, particularly preferably between 60:40 and 95:5.

In one particularly preferred embodiment of the present invention, which turned out to be particularly effective, the graft base is polyethylene glycol with a molecular weight of 5,000-7,000 g/mole, especially about 6,000 g/mole, and the graft branches comprise polyvinyl acetate, with the proportion of the graft base being about 55-95% by weight, especially 60, 65, 70, 80 or 90 percent by weight, and with the proportion of graft branches being correspondingly about 5-45% by weight, especially 10, 20, 30, 35 or 40% by weight.

Therefore another subject of the present invention is a process for manufacturing a grafted copolymer, wherein a polyethylene glycol with a molecular weight of 5,000-7,000 g/mole, especially about 6,000 g/mole, is grafted with an ester of a C₂₋₆ enol with a C₂₋₄ carboxylic acid, particularly with vinyl acetate, in which the ratio of weight percent between the polyethylene glycol and the unsaturated ester is between 50:50 and 199:1, especially between 55:45 and 95:5, and primarily 60:40, 65:35, 70:30, 80:20 or 90:10. Copolymers that can be obtained by such a process are further subjects of the present invention.

The data on the ratio of weight percentages refer primarily in each case to the ratio of the starting materials used. In case complete grafting occurs, the weight percent ratios for the starting materials match the average weight percent ratio of the graft copolymers obtained. Because of side reactions, the average weight percent ratio of the starting materials used can differ from the weight percent ratio of the graft copolymer obtained.

In one preferred embodiment, the graft copolymers have a molecular weight of 5,000 to 300,000, especially preferably 20,000 to 250,000, and primarily of 50,000 to 200,000 g/mole.

Polyurethanes

The previously cited polymeric structural elements according to the invention are preferably used in the form of diols to produce polyurethanes usable according to the invention. The diols can be converted to polyurethanes according to the invention by condensation with a diisocyanato compound. These diols are also called “polymeric diols” in the following. In one preferred embodiment, the condensation does not occur with these polymeric diols in production of the polyurethane. Instead, additional short-chain non-polymeric diols are added to the reaction mixture.

Accordingly, then, the previously cited polymeric structural elements according to the invention in the form of water-soluble polymers and/or copolymers, having a chain structure from the range of polyesters, polysaccharides, polyethers, polyurethanes, polyureas, polyamides, and/or mixtures thereof with a molecular weight of about 100 to 50,000, especially about 600 to about 35,000, preferably about 1,000 to 20,000, and especially preferably from 5,000 to 13,000 g/mole can be considered as polymeric diols for production of the polyurethanes. For example, short-chain polyurethanes, so-called PrePUs, which can be obtained by reaction of short-chain polyalkylene glycols, preferably polyethylene glycols or copolymers of ethylene glycol and propylene glycol, with a molecular weight of about 100 to about 1,000 g/mole, such as PEG 600PU, with isocyanates, can be used as polymeric diols. Water-soluble polyalkylene glycols, especially polyethylene glycols or copolymers of ethylene glycol and propylene glycol, with the previously stated molecular weights are also preferred as polymeric diols for production of the polyurethanes. It is also possible to use arbitrary mixtures of the previously mentioned polymers, especially the polyalkylene glycols, as hydrophilic diols.

However, in one preferred embodiment, additional short-chain non-polymeric diols having a molecular weight preferably less than 1,000 g/mole, especially less than 600 g/mole, are used as other diol components.

In one preferred embodiment the short-chain diols are optionally substituted aliphatic or acyclic, branched or unbranched, saturated or unsaturated diols having 2 to 50, especially 4 to 30, C atoms, in which the diols can also contain aromatic structures, ether groups and acid groups. The acid groups can, for example, be a carboxylic acid, a phosphonic acid or a sulfonic acid group. Examples of short-chain diols include 1,3-propanediol, 1,4-butanediol, 1,6-hexanediol, 1,10-decanediol, 1,12-dodecanediol, dimer fatty acid diols, 1,2-octanediol, 1,2-dodecanediol, 1,2-hexadecanediol, 1,2-octadecanediol, 1,2-tetradecanediol, 2-butene-1,4-diol, 2-butyne-1,4-diol, 2,4,7,9-tetramethyl-5-decyn-4,7-diol and their ethoxylation products as well as mono-fatty acid esters with fatty acids that contain up to 22 C atoms, such as glycerol monoesters of behenic acid, oleic acid, stearic acid or myristic acid. Furthermore, low-molecular-weight polyester dials such as the bis-hydroxyethyl esters of succinic acid, glutaric acid or adipic acid, or a mixture thereof, or low-molecular-weight diols with ether groups, especially α,ω-dimerdiols such as ethylene glycol, propylene glycol or α,ω-C₈₋₄₄ dimerdiols, triethylene glycol, tripropylene glycol, tetraethylene glycol or tetrapropylene glycol can also be considered as short-chain diols.

In a particularly preferred embodiment, the short-chain diol is a saturated diol with 4 to 8 C atoms, especially hexanediol, and particularly 16-hexanediol.

In another particularly preferred embodiment, the short-chain diol is a diol with 3 to 10 C atoms which carries a carboxylic acid group. This is particularly a hydroxypropanoic acid that is substituted by methyl and hydroxymethyl. It is especially 3-hydroxy-2-hydroxymethyl-2-methylpropanoic acid (2,2-bis(hydroxymethyl)propionic acid; DMPA). In another particularly preferred embodiment the short-chain diol is a saturated linear C₁₂₋₃₀ alkanediol with a primary and a secondary hydroxyl group, particularly 1,12-octadecanediol (Loxanol, Cognis).

Aside from the water-soluble polymeric diols listed above according to the invention, other polymeric diols that are less soluble in water can also be used as additional diol components. Examples thereof are polymers from the groups polypropylene glycol, polybutylene glycol, polybutadienediol or polytetrahydrofuran, preferably having a molecular weight of 250 to 6,000, especially preferably 650 to 4,000, and particularly 1,000 to 2,000 g/mole. Other additional components that can be used according to the invention are hydrophobic diols such as mono-fatty acid esters of glycerol with C₁₂₋₂₂ fatty acids and di-fatty acid esters of glycerol with a C₁₂₋₂₂ fatty acid and a C₁₂₋₂₂ hydroxy-fatty acid, such as occur for example in castor oil in the form of esters of ricinoleic acid.

All the compounds known to those skilled in the art can be used as the diisocyanato compound to produce the polyurethane. This is a compound having the general structure O═C═N—X—N═C═O, in which X is an optionally substituted aliphatic, alicyclic and/or aromatic group, preferably having 4 to 18 C atoms. The diisocyanato compound can in particular be one or more compounds selected from 1,5-naphthylene diisocyanate, 4,4′-diphenylmethane diisocyanate (MDI), hydrogenated MDI (H₁₂MDI), xylylene diisocyanate (XDI), tetramethylxylylene diisocyanate (TMXDI), 4,4′-diphenyldimethylmethane diisocyanate, di- and tetra-alkyldiphenylmethane diisocyanate, 4,4′-dibenzyl diisocyanate, 1,3-phenylene diisocyanate, 1,4-phenylene diisocyanate, the isomers of toluoylene diisocyanate (TDI), 1-methyl-2,4-diisocyanato-cyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid bis-isocyanatoethyl esterdiisocyanates with reactive halogen atoms, such as 1-chloromethylphenyl-1,4-diisocyanate, 1-bromomethylphenyl-2,6-diisocyanate, 3,3-bis-chloromethyl ether-4,4-diphenyldiisocyanate, sulfur-containing polyisocyanates which can be obtained, for example, by reaction of 2 moles of hexamethylene diisocyanate, with 1 mole of thiodiglycol or dihydroxydihexylsulfide, trimethylhexamethylene diisocyanate, 1,4-diisocyanatobutane, 1,12-diisocyanatododecane and dimer fatty acid diisocyanate. The following are especially suitable: tetramethylene-, hexamethylene-, undecane-, dodecamethylene-, 2,2,4-trimethylhexane-, 1,3-cyclohexane-, 1,4-cyclohexane-, 1,3- or 1,4-tetramethylxylene-, isophorone-, 4,4-dicyclohexylmethane- and lysine ester diisocyanates. α,α,α′,α′-tetramethyl-1,3-xylene diisocyanate, which is available from the Cyanamide company, for instance, is quite particularly preferred.

The diisocyanato compound and the diol component are preferably used in about an equimolar ratio, preferably with a slight excess of the alcohol component. The molar ratio of diisocyanato compound and the total amount of diol is preferably between 1:0.95 and 1:1.25, especially preferably between 1:1 and 1:1.1. If a short-chain diol is used along with the polymeric diol to make the polyurethane, then the polymeric diol and the short-chain diol are preferably used in a ratio of about 1:1 to 1:10, especially preferably about 1:2 to 1:5. In one preferably preferred embodiment the diisocyanato compound, polymeric diol and short-chain diol are used in the ratio of about 4:1:3.2, with the previously stated preferred molar ratio between diisocyanato compound and total diol maintained.

The polyurethanes are produced in the manner known to those skilled in the art. Crosslinking agents, especially polyisocyanates such as trimerization products of the previously cited diisocyanates, polyols such as trimethylolpropane (TMP), trimethylolethane, glycine, pentaerythritol, sorbitol, mannitol or glucose, or polyamines can also be used if necessary in production of small amounts of polyurethanes. Chain-terminators, especially monofunctional alcohols, monofunctional amines or monoisocyanates can likewise optionally be added to the reaction mixture in small proportions. The reaction mixture can likewise optionally contain diamines such as ethylenediamine or hexamethylenediamine. Also optionally, a catalyst, such as dibutyltin dilaurate (DBTL) can be added to the reaction mixtures. The concentration of alkali and alkaline earth metal ions should be less than 500 ppm, especially less than 150 ppm, preferably less than 10 ppm, and the water content should be less than 0.5, especially less than 0.1, and preferably less than 0.05% by weight to get high-molecular-weight polyurethanes. See Laid-Open Patent Applications EP0334032, WO 94/13726 and WO 03/035712 for further information on production of polyurethanes and especially production of high-molecular-weight polyurethanes using chain extenders.

The polyurethanes according to the patent are preferably nonionic polyurethanes. The average molecular weight of the polyurethanes is 5,000 to 250,000 in a preferred embodiment, especially preferably 10,000 to 200,000, and primarily 10,000 to 100,000 g/mole.

In one particularly advantageous embodiment of the invention, tetramethylxylylene diisocyanate (m-TMXDI), PEG 12000, 1,12-octadecanediol and DMPA are used to produce the polyurethane, preferably in ratios of about 4:1:2.2:1.

In another particularly advantageous embodiment of the invention, tetramethylxylylene diisocyanate (m-TMXDI), PEG 12000, 1,12-octadecanediol and 1,6-hexanediol are used to produce the polyurethane, preferably in ratios of about 4:1:2.2:1.

In a further particularly advantageous embodiment of the invention, m-TMXDI, PEG 8000, 1,12-octadecanediol and a prePU are used to produce the polyurethane, preferably in ratios of about 6.1:1:1.7.4. The prePU here is preferably obtainable by reaction of 1.35 parts of PEG_{—}600PU (Clariant) with 1 part of MDI (Desmodur 44M, Bayer), and has a molecular weight of about 3,000 g/mole.

In a further particularly advantageous embodiment, MDI, PEG 6000 and PEG 600 are used to produce the polyurethane, preferably in the ratios of about 1:0.1:1.

Thus a further subject of the present invention is a process for producing a polyurethane wherein a diisocyanate, especially m-TMXDI, is reacted with a polyethylene glycol having a molecule weight of 11,000-13,000 g/mole, especially about 12,000 g/mole; with a diol having 16 to 20 C atoms, especially with 1,12-octadecanediol; and with a diol having 4 to 8 C atoms, especially with DMPA or 1,6-hexanediol, in the proportion of about 4:1:2.2:1. A polyurethane obtainable by this process is a further subject of the present invention.

Thus a further subject of the present invention is a process for producing a polyurethane, wherein a diisocyanate, especially m-TMXDI, is reacted with a polyethylene glycol having a molecular weight of 5,000 to 7,000, especially about 6,000 g/mole; with a diol having 16 to 20 C atoms, especially 1,12-octadecanediol; and with a prePU having a molecular weight of 2,500 to 3,500, especially a prePU such as can be obtained by reaction of about 1.35 parts of PEG_{—}600PU (Clariant) with 1 part of MDI in the proportion of about 6.1:1:1.7:4. Therefore a polyurethane obtainable by this process is a further subject of the present invention.

Thus a further subject of the present invention is equally a process for producing a polyurethane, wherein a diisocyanate, especially MDI, is reacted with a polyethylene glycol having a molecular weight of 5,000 to 7,000, especially about 6,000 g/mole and a polyethylene glycol having a molecular weight of 500 to 700, especially about 600 g/mole, in the proportion of about 1:0.1:1.

Capsules

It was also found, surprisingly, that the polymer that has anti-adhesive action against microorganisms can be incorporated very well into capsules which can, in turn, be added to washing and cleaning agents and produce a visually advantageous effect.

Therefore a further subject of the present invention is capsules comprising polymers having anti-adhesive action against microorganisms according to the invention. The capsules preferably contain the polymers with anti-adhesive action in a proportion of 1-30, especially preferably 5-25, and particularly 10-20% by weight.

Two different types of capsules are distinguished. One type is capsules with a core-shell structure, with which the contents are surrounded by a wall or barrier. The other type is capsules in which the contents are distributed through a matrix of a matrix-forming material. The latter type of capsules are also called “speckles”. According to the invention, the polymers with anti-adhesive action can be contained in either kind of capsule.

Examples include microcapsules with polyvinyl alcohol coating, such as are described in EP 0266796 A1; capsules with a water-soluble coating of cellulose ether, polyacrylate, polyvinyl alcohol or polyethylene oxide, such as are disclosed in GB 1390503 A; capsules of hardened carrageenan or modified pectin, such as are described in GB 1461775 A; and capsules of a gelled polymeric material such as are described in WO 97/14780. See the disclosure of WO 97/24178 for other capsules usable according to the invention.

A preferred embodiment concerns capsules comprising the polymers with anti-adhesive action around the previously mentioned “speckles”, thus, capsules of a matrix of a matrix-forming material, which matrix-forming material preferably involves polymers, so that this type of capsules is also called “polymeric matrix structures” in the following.

These polymeric matrix structures are especially preferably those such as are described in patent applications DE2215441 and EP1149149. Explicit reference is made to those patent applications with respect to the form, organization, properties, structure, and manufacture of the capsules, and the material disclosed in them is hereby made a subject of the present application. Some important and optionally even slightly deviant properties of the capsules are presented in the following.

The capsules comprise essentially a water-soluble polymeric wall material that can be gelled into a continuous matrix. Thus these are capsules, the surfaces of which comprise a water-soluble polymer in gel form, for which the water-soluble polymer and the nature and concentration of electrolytes are selected so that the polymer is resistant in a washing agent and becomes soluble when the washing agent is diluted with water.

Suitable water-soluble polymers that are suitable for producing preferred capsules according to the invention are insoluble in 20% (w/v) aqueous sodium sulfate, 30% (w/v) aqueous sodium citrate or 30% (w/v) aqueous sodium tartrate. They can be selected with the following selection test, for example:

0.5 ml of a dilute solution of a polymer to be tested for its suitability is added slowly to 10 ml of a solution containing sodium sulfate in the concentration range of 0.5 to 20% (w/v). Those polymers that rapidly form a cohesive gelatinous precipitate in the presence of 20% (w/v) or lower, preferably even at 10% (w/v) or lower sodium sulfate at 0, 25 and 50° are suitable. See DE2215441 for other suitable selection tests.

Suitable polymers are selected, for example, from naturally occurring polysaccharides, especially pectin, carrageenan, alginic acid and amylopectin; from cellulose ethers, including methylcellulose, hydroxyethylcellulose, hydroxypropylcellulose and carboxymethylcellulose; from completely synthetic polymers, especially polyvinyl alcohol, polyvinyl acetates hydroxylated to various degrees, polyacrylic acid and polyethoxyethers, as well as from proteins, especially gelatin. Especially preferred polymers are selected from carrageenan, alginate and gellan gum. Alginate is quite specially preferred.

Alginate is a naturally occurring salt of alginic acid. It occurs as a cell wall constituent in all brown algae (Phaeophycea). Alginates are acidic polysaccharides that contain carboxyl groups, with a relative molecular weight M_{R} of about 200,000. They are made up of D-mannuronic acid and L-guluronic acid in various ratios, bonded with 1,4-glycosidic bonds. The sodium, potassium, ammonium and magnesium alginates are water-soluble. The viscosity of alginate solutions depends, among other things, on the molecular weight and on the counterion. At certain weight ratios, for instance, calcium alginates form gels that are not thermally reversible. Sodium alginates give very viscous solutions with water, and can be cross-linked by interaction with divalent or trivalent metal ions such as Ca²⁺. In that way, materials contained in the aqueous sodium alginate solution are also enclosed in an alginate matrix.

Carrageenan is an extract of the red algae (Chondrus cripsus and Gigartina stellata), which are included in the floridean algae. Carrageenan cross-links in the presence of K⁺ or Ca²⁺ ions.

Gellan gum is an unbranched anionic microbial heteroexopolysaccharide with a tetrasaccharide base unit consisting of the monomers glucose, glucuronic acid and rhamnose, with each basic unit esterified with L-glycerate and every other basic unit esterified with an acetate. Gellan gum cross-links in the presence of K⁺ ions, Na⁺, Ca²⁺ ions or Mg²⁺ ions.

Polymeric matrix structures that contain antiadhesive polymers against microorganisms according to the invention can be produced simply by dropping solutions of those polymers into solutions that contain cations. Depending on the polymer of the matrix structure, the cations are preferably alkali and/or ammonium and/or alkaline earth ions, for which the anion is freely selectable. Basically, alkali, ammonium and alkaline earth salts of any desired inorganic and/or organic acid can be used.

To produce alginate-based capsules, it is preferable to make droplets from an aqueous alginate solution which also contains the polymers with antiadhesive action to be included, and optionally other components such as fillers, hollow micro-beads, preservatives and coloring agents, and then to harden them in a coagulating bath that contains Ca²⁺ ions.

For example, the capsules can be produced using a dropping system from Rieter Automatik GmbH. The aqueous polymer solution that contains the polymers with antiadhesive action, and optionally filler(s), hollow microbeads, preservatives and coloring agents by applying an oscillation produced using an oscillating membrane. The drops are separated by the increased shearing action when the membrane oscillates backward. The droplet production itself can be accomplished with a single nozzle or by a nozzle plate with 10 to 500, preferably 50 to 100, openings. The nozzles preferably have openings with diameters in the range of 0.2 to 2, preferably 0.3 to 0.8 mm. The droplets can essentially be generated in a coagulating batch, which is designed as a stirred tank or kettle. Here, though, there is a danger that the capsules may strike each other adhere. Furthermore, during the stirring, the capsules and the active ingredient in them can be destroyed again, as the stirring also causes an undesired temperature rise by adding energy. Those disadvantages can be avoided if the coagulation bath is designed as a kind of flow channel. The droplets are produced in a uniform flow that moves the drops out of the formation zone so rapidly that they cannot be struck by following drops and adhere to them. As long as the capsules are not fully hardened, they float. As the hardening advances, they sediment.

Other droplet formation systems that differ by using different droplet formation systems can also be used as alternative production methods. As examples, we cite here systems from the companies Gouda, Cavis, or GeniaLab. Refer to DE2215441 for other production processes.

The proportion of alginate in the aqueous alginate solution is preferably between 0.01 and 10% by weight, especially preferably between 0.1 and 5% by weight, and particularly preferably between 1 and 3% by weight. It is preferable to use sodium alginate.

It may be advantageous then to wash the alginate-based capsules with water and then to wash them in an aqueous solution of a complexing agent such as Dequest to leach out free Ca²⁺ ions, which could enter into undesired interactions with components of the liquid washing and cleaning agents, such as fatty acid soaps. Then the alginate-based capsules are washed once again with water to remove excess complexing agent.

The capsules can be dried before they are used in a washing and cleaning agent, but it is preferable to use them wet.

The capsules can have any desired diameter, especially a diameter between 1 μm and 1 cm. It is preferable for the size of the capsules to be in the visible range, preferably between 0.5 and 4.0 mm, measured along their longest dimension. These capsules can have any desired structure, but they have preferably a round or approximately round form.

The capsules can also contain fillers, such as, preferably, silicic acids or aluminum silicates, especially zeolites. To incorporate those fillers, the corresponding materials are added to the alginate solution. Silicic acids, suitable as fillers, are commercially available under the names Aerosil® or Sipernat® (both from Degussa). Aluminum silicates and especially zeolites are other suitable fillers. Zeolite A, Zeolite P, Zeolite X or mixtures thereof can be used. Examples of suitable zeolites include commercial products such as Wessalith® (from Degussa); Zeolite MAP® (from Crosfield) or VEOBOND AX® (from SASOL).

The proportion of filler in the aqueous alginate solution is preferably between 0 and 20% by weight; more preferably between 1 and 10% by weight; and particularly preferably between 2 and 10% by weight.

The fillers give the capsules a robust structure, for one thing, thus having a positive effect on the stability of the capsules. In addition to that, the fillers, especially the silicic acids, can improve the solubility of the capsules in the washing process itself.

In one preferred embodiment, the capsule also comprises at least one hollow microbead. Hollow microbeads have diameters of 2 to 500 μm, especially of 5 to 20 μm, and a specific weight of less than 1 g·cm⁻³. By incorporating one or more hollow microbeads into the individual capsules, the densities of the capsules can be matched to the density of the surrounding washing and cleaning agent composition, thus preventing the undesirable settling or floating (creaming) of the capsules. It is convenient for the hollow microbeads to be round and smooth. The hollow microbeads can be of inorganic material such as water glass, aluminum silicate, borosilicate glass, soda-lime glass, or a ceramic; or of organic polymers such as homopolymers or copolymers of styrene, acrylonitrile and vinylidene chloride. Suitable hollow microbeads are commercially available under the names Fillite® (from Trelleborg Fillite), Expancel® (from Akzo Nobel), Scotchlite® (from 3M), Dualite® (from Sovereign Specialty Chemicals), Sphericel® (from Potter Industries), Zeeospheres® (from 3M), Q-Cel® (from PQ Corporation) or Extendospheres® from PQ Corporation). Other suitable hollow microbeads are offered by OMEGA MINERALS as E-Spheres. E-Spheres are white ceramic microbeads that are offered in various particle sizes, particle size distributions, bulk densities, and bulk volumes. Many of the hollow microbeads mentioned are chemically inert. After the capsule is destroyed, they are dispersed in the washing liquid and then removed with it.

As already noted above, the density of the capsules can be varied or adjusted by incorporating hollow microbeads. The proportion of hollow microbeads in a capsule depends on the desired density of the capsule. However, it is preferred that the proportion of hollow microbeads in the aqueous alginate solution be preferably between 0 and 10% by weight, more preferably between 1 and 5% by weight, and especially preferably between 2 and 4% by weight.

It may be desirable for aesthetic reasons that the capsules be colored. The capsules can comprise one or more coloring agents such as a pigment or a dye for that purpose. It may also be desirable for the capsule to comprise a preservative.

The active ingredients are usually released from the capsules as a result of destruction of the matrix by mechanical, thermal, chemical or enzymatic action during use of the agent containing them. In one preferred embodiment of the invention, the liquid washing and cleaning agents comprise the same or different capsules in ratios of 0.01 to 10% by weight, especially 0.2 to 8% by weight, and extremely preferably 0.5 to 5% by weight.

Agents, especially washing and cleaning agents as well as textile treatment agents comprising polymers with antiadhesive action according to the invention and/or the previously specified capsules according to the invention, especially polymeric matrix structures, are also a subject of the present invention.

The agent according to the invention preferably contains the polymers with antiadhesive action in an proportion of 0.01-5, especially preferably 0.05-1% by weight, so that the finished washing liquid preferably contains an amount of polymer with antiadhesive action that is lower by a factor of 1:100 to 1:200.

The agent can also contain different capsules of different sizes, different composition and/or different concentrations. If other capsules are contained, they can preferably comprise sensitive, chemically or physically incompatible or volatile components of the washing and/or cleaning agent which can in this manner be enclosed so as to be preferably stable to storage and transportation. The means according to the invention preferably contains the capsules in a proportion of 1-10% by weight.

Aside from the capsules, the liquid washing and cleaning agents contain surfactants. Anionic, nonionic, cationic and/or amphoteric surfactants can be used. From the viewpoint of application technology, it is preferable to use mixtures of anionic and nonionic surfactants. The total surfactant concentration of the liquid washing and cleaning agent is preferably less than 40% by weight and especially preferably less than 35% by weight, based on the total liquid washing and cleaning agent.

The nonionic surfactants used are preferably alkoxylated, advantageously ethoxylated, particularly primary alcohols with preferably 8 to 18 C atoms and an average of 1 to 12 moles of ethylene oxide (EO) per mole of alcohol, in which the alcohol group can be linear or preferably has a methyl branch in the 2 position or can comprise linear and methyl-branched groups in the mixture, such as are usually present in oxoalcohol groups. However, alcohol ethoxylates with linear groups from alcohols of natural origin having 12 to 18 C atoms, such as from coconut, palm, tallow or oleyl alcohol, and having an average of 2 to 8 EO per mole of alcohol are particularly preferred. Examples of the preferred ethoxylated alcohols include C₁₂₋₁₄ alcohols with 3 EO, 4 EO or 7 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO, and mixtures thereof, such as mixtures of C₁₂₋₁₄ alcohol with 3 EO and C₁₂₋₁₈ alcohol with 7 EO. The stated degrees of ethoxylation are statistical averages, which can, for a specific product, be an integer or a fractional number. Preferred alcohol ethoxylates exhibit a narrow distribution of homologs (narrow range ethoxylates, NRE). Fatty alcohols with more than 12 EO can also be used in addition to these nonionic surfactants. Examples thereof are tallow fatty alcohols with 14 EO, 25 EO, 30 EO or 40 EO. Nonionic surfactants which contain EO and PO groups together in the molecule are also usable according to the invention Block copolymers with EO-PO block units or PO-EO block units can be used, as well as EO-PO-EO copolymers or PO-EO-PO copolymers. Obviously, mixed alkoxylated nonionic surfactants in which the EO and PO units are not in blocks but are randomly distributed are also usable. Such products are obtainable by simultaneous action of ethylene oxide and propylene oxide on fatty alcohols.

Alkylglycosides having the general formula RO(G)ₓ can also be used as other nonionic surfactants. Here R represents a primary straight-chain or methyl-branched aliphatic group, especially one methyl-branched in the 2 position, having 8 to 22, preferably 12 to 18 C atoms; and G is the symbol for a glycose unit with 5 or 6 C atoms, preferably glucose. The degree of oligomerization x, which indicates the distribution of monoglycosides and oligoglycosides, is any desired number between 1 and 10. Preferably, x is 1.2 to 1.4.

A further class of preferred nonionic surfactants used, which are used either as the only nonionic surfactant or in combination with other nonionic surfactants, is alkoxylated, preferably ethoxylated or ethoxylated and propoxylated fatty acid alkyl ester, preferably having 1 to 4 carbon atoms in the alkyl chain, especially fatty acid methyl esters such as are described in the Japanese Patent Application JP 58/217598 or are produced by the process described in International Patent Application WO-A-90/13533.

Nonionic surfactants of the amino oxide type, such as N-cocoalkyl-N,N-dimethylamine oxide and N-tallow-alkyl-N,N-dihydroxyethylamine oxide, and the fatty acid alkanolamides can also be suitable. The amount of these nonionic surfactants is preferably not more than that of the ethoxylated fatty alcohols, especially not more than half of that.

Other suitable surfactants are polyhydroxyfatty acid amides having the formula (1)

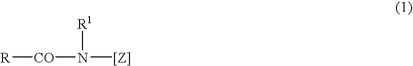

in which RCO stands for an aliphatic acyl group with 6 to 22 carbon atoms, R¹ stands for hydrogen, an alkyl or hydroxyalkyl group with 1 to 4 carbon atoms, and Z stands for a linear or branched polyhydroxyalkyl group with 3 to 10 carbon atoms and 3 to 30 hydroxyl groups. The polyhydroxyfatty acid amides are known materials that can usually be obtained by reductive amination of a reducing sugar with ammonia, an alkylamine or an alkanolamine, and subsequent acylation with a fatty acid, a fatty acid alkyl ester or a fatty acid chloride.

The group of polyhydroxyfatty acid amides also includes compound of formula (2),

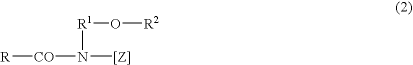

in which R stands for a linear or branched alkyl or alkenyl group with 7 to 12 carbon atoms, R¹ stands for a linear, branched or cyclic alkyl group or an aryl group with 2 to 8 carbon atoms, and R² stands for a linear, branched or cyclic alkyl group or an aryl group or an oxyalkyl group with 1 to 8 carbon atoms, with C₁₋₄ alkyl groups or phenyl groups preferred, and [Z] stands for a linear polyhydroxyalkyl group, the alkyl chain of which is substituted with at least two hydroxyl groups, or alkoxylated, preferably ethoxylated or propoxylated derivates of this group.

[Z] is preferably obtained by reductive amination of a sugar, such as glucose, fructose, maltose, lactose, galactose, mannose or xylose. Then the N-alkoxy or N-aryloxy substituted compound can, for instance, be converted into the desired polyhydroxyfatty acid amides by reaction with fatty acid methyl esters in the presence of an alkoxide as the catalyst, according to the teaching of International Application WO-A-95/07331, for instance.

The liquid washing and cleaning agents are preferred to have ratios of 5 to 30% by weight, preferably 7 to 20% by weight and especially 9 to 15% by weight of nonionic surfactants, based in each case on the total agent.

Surfactants of the sulfonate and sulfate type, for example, are used as anionic surfactants. Surfactants of the sulfonate type that can be considered include, preferably, C₉₋₁₃ alkylbenzenesulfonates, olefin sulfonates, i.e., mixtures of alkene and hydroxyalkane sulfonates, and disulfonates, such as are obtained, for example, from C₁₂₋₁₈ mono-olefins with terminal or internal double bonds by sulfonation with gaseous sulfur trioxide and subsequent alkaline or acidic hydrolysis of the sulfonation products. Alkane sulfonates obtained, for instance, from C₁₂₋₁₈ alkanes by chlorosulfonation or sulfoxidation with subsequent hydrolysis or neutralization are also suitable. Likewise, esters of α-sulfofatty acids (ester sulfonates) such as the α-sulfonated methyl esters of hydrogenated coconut, palm nut, or tallow fatty acids are also suitable.

Sulfonated fatty acid glycerol esters are other suitable anionic surfactants. Fatty acid glycerol esters are understood to be the mono, di and tri-esters and mixtures thereof such as those obtained by esterification of a monoglycerol with 1 to 3 moles of fatty acid or by transesterification of triglycerides with 0.3 to 2 moles of glycerol. Preferred sulfonated fatty acid glycerol esters are the sulfonation products of saturated fatty acids with 6 to 22 carbon atoms, especially caproic acid, caprylic acid, capric acid, myristic acid, lauric acid, palmitic acid, stearic acid or behenic acid.

Preferred alk(en)yl sulfates are the alkali salts, especially the sodium salts, of sulfuric acid monoesters of the C₁₂-C₁₈ fatty alcohols, such as coconut fatty alcohol, tallow fatty alcohol, lauryl, myristyl, cetyl or stearyl alcohol, or of the C₁₀-C₂₀ oxoalcohols and the monoesters of secondary alcohols having those chain lengths. Further preferred are alk(en)yl sulfates of the stated chain lengths that contain a synthetic straight-chain alkyl group produced petrochemically, which have degradation behavior analogous to the appropriate compounds based on fatty chemical raw materials. The C₁₂₋₁₆ alkyl sulfates and C₁₂₋₁₅ alkyl sulfates and the C₁₄₋₁₅ alkyl sulfates are preferred with respect to laundry technology. 2,3-alkyl sulfates, which can, for instance, be produced according to the U.S. Pat. No. 3,234,258 or 5,075,041 and are commercially available from Shell Oil company under the DAN® name, are also suitable anionic surfactants.

The sulfuric acid mono-esters of straight-chain or branched C₇₋₂₁ alcohols ethoxylated with 1 to 6 moles of ethylene oxide, such as the 2-methyl branched C₉₋₁₁ alcohols with an average of 3.5 moles of ethylene oxide (EO) or C₁₂₋₁₈ fatty alcohols with 1 to 4 EO are also suitable. They are used in cleaning agents only in relatively small proportions because of their high foaming ability, for example, in ratios of 1 to 5% by weight.

The salts of alkylsulfosuccinic acid, also known as sulfosuccinates or sulfosuccinic acid esters, and the monoesters and/or diesters of sulfosuccinic acid with alcohols, preferably fatty alcohols and in particular ethoxylated fatty alcohols are also suitable anionic surfactants. Preferred sulfosuccinates contain C₈₋₁₈ fatty alcohol groups or mixtures thereof. Particularly preferred sulfosuccinates contain a fatty alcohol group derived from ethoxylated fatty alcohols which are themselves nonionic surfactants (see below for their description). Sulfosuccinates having fatty alcohol groups derived from ethoxylated fatty alcohols with restricted homolog distribution are particularly preferred. Likewise, it is also possible to use alk(en)ylsuccinic acids with preferably 8 to 18 carbon atoms in the alk(en)yl chain, or salts thereof.

Soaps are particularly preferred anionic surfactants. Saturated and unsaturated fatty acid soaps such as the salts of lauric acid, myristic acid, palmitic acid, stearic acid, (hydrogenated) erucic acid and behenic acid and, in particular, soap mixtures derived from natural fatty acids, such as coconut, palm nut, olive oil or tallow fatty acids are suitable.

The anionic surfactants, including the soaps, can be in the form of their sodium, potassium or ammonium salts, as well as soluble salts of organic bases such as mono-, di-, or tri-ethanolamine. The anionic surfactants are preferably in the form of their sodium or potassium salts, especially in the form of the sodium salts.

The preferred liquid washing and cleaning agents comprise 2 to 30% by weight, preferably 4 to 25% by weight, and particularly preferably 5 to 22% by weight of anionic surfactants, based in each case on the total agent.

The viscosity of the liquid washing and cleaning agent can be determined with the usual standard methods (such as the Brookfield LVT-II Viscosimeter at 20 rpm and 20° C., with spindle 3). It is preferably in the range of 500 to 5,000 mPas. Preferred agents have viscosities of 700 to 4000 mPas, with values between 1,000 and 3,000 mPas particularly preferred.

The liquid washing and cleaning agents can have other ingredients that further improve the applications technical and/or aesthetic properties of the liquid washing and cleaning agents. Within the scope of the present invention, preferred agents contain one or more substances from the groups of builders, bleaches, bleach activators, enzymes, electrolytes, nonaqueous solvents, pH-adjusting agents, fragrances, perfume carriers, fluorescent agents, dyes, hydrotropes, foam inhibitors, silicone oils, antiredeposition agents, optical brighteners, graying inhibitors, shrinkage preventers, anti-wrinkling agents, color bleeding inhibitors, antimicrobially active substances, germicides, fungicides, antioxidants, corrosion inhibitors, antistatic agents, pressing aids, repellent agents and impregnants, anti-swelling and anti-slip agents, and UV absorbers.

Builders that may be contained in the liquid washing and cleaning agents particularly include, but are not limited to, silicates, aluminum silicates (especially zeolites), carbonates, salts of organic dicarboxylic and polycarboxylic acids, and mixture of those materials.

Suitable crystalline laminar sodium silicates have the general formula NaMSiₓO_{2x+1·H2O}, in which M means sodium or hydrogen, x is a number from 1.9 to 4, and y is a number from 0 to 20, and preferred values of x are 2, 3 or 4. Such crystalline silicates are described, for example, in the European Patent Application EP-A-0 164 514. Preferred crystalline laminar silicates of the formula given are those in which M stands for sodium and x has the value of 2 or 3. Both β- and δ-sodium disilicates Na₂Si₂O₅.yH₂O are particularly preferred. β-sodium disilicate can be obtained, for example, by the process described in the International Patent Application WO-A-91108171.

Amorphous sodium silicates with a Na₂O:SiO₂ ratio of 1:2 to 1:3.3, preferably 1:2 to 1:2.8 and especially preferably of 1:2 to 1:2.6, which are slow-dissolving and have secondary laundering properties, are also usable. The delayed dissolution compared to the usual amorphous sodium silicates can be produced in various ways, such as by surface treatment, compounding, compacting/densification or by over-drying. In the scope of this invention, the concept “amorphous” is also understood to mean “X-ray amorphous”. That means that the silicates do not yield any sharp X-ray reflections in X-ray diffraction experiments, such as are typical of crystalline substances, but always give one or more maxima for the scattered X-radiation indicating a range of several degrees for the angle of diffraction. However, it can result in very good or even particularly good builder properties if the silicate particles yield faded or even sharp diffraction maxima in electron diffraction experiments. That is interpreted as that the products have microcrystalline regions having sizes of 10 to a few hundred nm, with values up to a maximum of 50 nm and especially up to a maximum of 20 nm preferred. Such so-called X-ray amorphous silicates, which likewise exhibit delayed dissolution compared with the normal water glasses, are described, for example, in the German Patent Application DE-A-44 00 024. Densified/compacted amorphous silicates, compounded amorphous silicates, and over-dried X-ray amorphous silicates are particularly preferred.

The finely crystalline synthetic zeolite containing bound water that is preferred for use is Zeolite A and/or Zeolite P. MAP® Zeolite (commercial product of Crosfield) is particularly preferred as Zeolite P. However, Zeolite X is also suitable, as are mixtures of A, X and/or P. For example, a co-crystallite of Zeolite X and Zeolite A (about 80% by weight Zeolite X) is commercially available and is particularly preferably usable in the scope of the present invention. It is marketed by Sasol under the trade name VEGOBOND AX®, and can be described by the formula

nNa₂O.(1−n)K₂O.Al₂O₃.(2−2.5)SiO₂.(3.5−5.5)H₂On=0.90−1.0

The zeolite can be used as the spray-dried powder or as the undried stabilized suspension, still wet from its production. In case the zeolite is used as the suspension, it can comprise minor additions of nonionic surfactants as stabilizers, such as 1 to 3% by weight, based on the zeolite, of ethoxylated C₁₂-C₁₈ fatty alcohols with 2 to 5 ethylene oxide groups, C₁₂-C₁₄ fatty alcohols with 2 to 5 ethylene oxide groups, or ethoxylated isotridecanols. Suitable zeolites have an average particle size of less than 10 μm (volume distribution; measurement method: Coulter counter) and contain preferably 18 to 22% by weight, especially 20 to 22% by weight of bound water.

It is obviously also possible to use the generally known phosphates as builders, to the extent that their use need not be avoided for ecological reasons. The sodium salts of the orthophosphates, pyrophosphates and, especially, the tripolyphosphates are particularly suitable.

Of the compounds that yield H₂O₂ and act as bleaches, sodium perborate tetrahydrate and sodium perborate monohydrate are of particular importance. Other usable bleaching agents are, for example, sodium percarbonate, peroxypyrophosphate, citrate perhydrate, and peracid salts or peracids that yield H₂O₂ such as perbenzoates, peroxophthalates, diperazelaic acid, phthaloiminoperacids or diperdodecandioic acids.

Bleach activators can be incorporated into the washing and cleaning agents to achieve improved bleaching action at temperatures of 60° C. and below. Compounds that can be used as bleach activators are those that yield aliphatic peroxocarboxylic acids with preferably 1 to 10 C atoms, especially 2 to 4 C atoms and/or optionally substituted perbenzoic acid under perhydrolysis conditions. Substances that have O-acyl groups and/or N-acyl groups with the stated number of C atoms and/or optionally substituted benzoyl groups are suitable. Preferred substances include multiply acylated ethylenediamines, especially tetraacetylethylenediamine (TAED); acylated triazine derivatives, especially 1,5-diacetyl-2,4-diketohexahydro-1,3,5-triazine (DADHT); acylated glycourils, especially tetraacetylglycouril (TAGU); N-acylimides, especially N-nonanoylsuccinimide (NOSI); acylated phenolsulfonates, especially n-nonanoyl- or isononanoyloxybenzenesulfonate (n- or iso-NOBS); carboxylic acid anhydrides, especially phthalic acid anhydride; acylated multifunctional alcohols, especially triacetin, ethylene glycol diacetate and 2,5-diacetoxy-2,5-dihydrofuran.

So-called ‘bleach catalysts’ can also be incorporated in the liquid washing and cleaning agents in addition to, or in place of the conventional bleach activators. These substances are transition metal salts or transition metal complexes which intensify bleaching, such as Mn, Fe, Co, Ru or Mo salen complexes or carbonyl complexes. Mn, Fe, Co, Ru, Mo, Ti, V and Cu complexes with nitrogen-containing tripod ligands as well as Co, Fe, Cu and Ru amine complexes can also be used as bleach catalysts.

The liquid washing and cleaning agent preferably contains a thickener. The thickener can, for instance, be a polyacrylate thickener, xanthan gum, gellan gum, guar bean meal, alginate, carrageenan, carboxymethylcellulose, bentonite, wellan gum, carob bean meal, agar-agar, tragacanth, gum arabic, pectins, polyoses, starches, dextrins, gelatins and casein. Modified natural substances, such as modified starches and celluloses, can also be used as thickeners. Examples include carboxymethylcellulose and other cellulose ethers, hydroxyethyl cellulose and hydroxypropyl cellulose, as well as bean meal ethers.

The polyacrylic and polymethacrylic thickeners include, for example, high-molecular-weight homopolymers of acrylic acid cross-linked with a polyalkenyl polyether, especially an allyl ether of sucrose, pentaerythritol or propylene (INCI designation according to “International Dictionary of Cosmetic Ingredients” from “The Cosmetic, Toiletry and Fragrance Association (CTFA)”: Carbomers), also known as carboxyvinyl polymers. Such polyacrylic acids can be obtained from, among others, 3V Sigma, under the trade name of Polygel®, e.g., Polygel DA, and from B.F. Goodrich under the trade name of Carbopol®, e.g., Carbopol 940 (molecular weight ca. 4,000,000), Carbopol 941 (molecular weight ca. 1,250,000) or Carbopol 934 (molecular weight ca. 3,000,000). The term also includes the following acrylic acid copolymers:
a. (i) copolymers of two or more monomers from the group of acrylic acid, methacrylic acid, and their simple esters, preferably produced with C₁₋₄ alkanols (INCI acrylates copolymer), including the copolymers of methacrylic acid, butyl acrylate and methyl methacrylate (CAS designation according to Chemical Abstracts Service: 25035-69-2) or of butyl acrylate and methyl methacrylate (CAS 25852-37-3). They can be obtained, for example, from Rohm & Haas under the trade names Aculyn® and Acusol®, and from Degussa (Goldschmidt) under the trade name Tego® polymer, such as the anionic non-associative polymers Aculyn 22, Aculyn 28, Aculyn 33 (cross-linked), Acusol 810, Acusol 820, Acusol 823 and Acusol 830 (GAS 25852-37-3);
b. (ii) cross-linked high-molecular-weight acrylic acid copolymers, including the copolymers of C₁₀₋₃₀ alkyl acrylates cross-linked with an allyl ether of sucrose or of pentaerythritol with one or more monomers from the group of acrylic acid, methacrylic acid and their simple esters, preferably those formed with C₁₋₄ alkanols (INCI Acrylates/C₁₀₋₃₀ alkyl acrylate crosspolymer). They can be obtained, for example, from B.F. Goodrich under the trade name Carbopol, such as hydrophobized Carbopol ETD 2623 and Carbopol 1382 (INCI Acrylates/C₁₀₋₃₀ alkyl acrylate crosspolymer) and Carbopol Aqua 30 (previously Carbopol EX 473).

Xanthan gum is another polymer preferred for use as a thickener. It is an anionic microbial heteropolysaccharide produced under aerobic conditions by Xanthomonas campestris and some other species, and has a molecular weight of 2 to 15 million Daltons. Xanthan is made up of a chain of β-1,4-linked glucose units (cellulose) with side chains. The structure of the subgroups comprises glucose, mannose, glucuronic acid, acetate and pyruvate, with the number of pyruvate units determining the viscosity of the xanthan gum. Xanthan gum can be obtained, for example, from Kelco under the trade names Ketrol® and Kelzan®, or from Rhodia under the trade name of Rhodopol®.

Preferred liquid washing and cleaning agents contain 0.01 to 1% by weight, preferably 0.1 to 5% by weight thickener, based on the complete agent.

The aqueous liquid washing and cleaning agents can comprise enzymes in encapsulated form and/or directly in the washing and cleaning agent composition. Enzymes to be considered include but are not limited to those of the hydrolase class, such as proteases, esterases, lipases or enyzymes with lipolytic action, amylases, cellulases or other glycosylhydrolases and mixtures of those enzymes. In the laundry, all those hydrolases can furthermore contribute to removal of stains such as stains containing protein, fat or starch, and graying. Cellulases and other glycosylhydrolases can also contribute to color retention and to increasing the softness of textiles by removal of pilling and microfibrils. Oxidoreductases can also be used for bleaching or to prevent color bleeding. Enzymatic active ingredients obtained from bacterial strains or fungi such as Bacillus subtilis, Bacillus lichenformis, Streptomyces griseus and Humicola insolens. Proteases of the subtilisin type, and especially proteases obtained from Bacillus lentus, are used preferably. Mixtures of enzymes are of special interest, such as mixtures of protease and amylase, or protease and lipase or enzymes with lipolytic action, or protease and cellulase, or cellulase and lipase or enzymes with lipolytic action, or protease, amylase, and lipase or enzymes with lipolytic action, or protease, lipase or enzymes with lipolytic action and cellulase, but particularly mixtures containing protease and/or lipase or mixtures with enzymes having lipolytic action.

The known cutinases are examples of such enzymes with lipolytic action. Even peroxidases or oxidases have proven to be suitable in some cases. The suitable amylases include in particular α-amylases, isoamylases, pullulanases and pectinases. Cellobiohydrolases, endoglucanases and β-glucosidases, also called cellobiases, or mixtures thereof are used preferably. As different cellulase types differ in their CMCase and Avicelase activities, the desired activities can be adjusted by intentional mixing of the cellulases.

The enzymes can be adsorbed on carriers for protection against premature degradation. The proportion of the enzymes, enzyme mixtures or enzyme granulations directly in the wash and cleaning agent composition can, for example, be about 0.1 to 5% by weight, preferably 0.12 to about 2.5% by weight.

A wide number of quite different salts from the group of inorganic salts can be used as electrolytes. The alkali and alkaline earth metals are preferred cations, and the halides and sulfates are preferred anions. From the viewpoint of production engineering, it is preferable to use NaCl or MgCl₂ in the agents. The proportion of electrolytes in the agents is usually 0.5 to 5% by weight.

Nonaqueous solvents that can be used in the liquid washing and cleaning agents are obtained, for example, from the group of monofunctional or multifunctional alcohols, alkanolamines or glycol ethers, to the extent that they are miscible with water in the specified concentration range. The solvents are preferably selected from ethanol, n-propanol or isopropanol, butanols, glycol, propanediol or butanediol, glycerol, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, di-isopropylene glycol monomethyl or monoethyl ether, methoxy, ethoxy, or butoxy triglycol, 1-butoxy-2-propanol, 3-methyl-3-methoxybutanol, propylene glycol t-butyl ether and mixtures of those solvents. Nonaqueous solvents can be used in the liquid washing and cleaning agents in ratios between 0.5 and 15% by weight, but preferably less than 12% by weight and especially preferably less than 9% by weight.

Us of pH-adjusting agents may be indicated to bring the pH of the liquid washing and cleaning agents to the desired range. All the known acids or bases are usable here as long as their use is not ruled out for application-technology or ecological reasons, or for user protection. usually the proportion of this pH-adjusting agent does not exceed 7% by weight of the total formulation.

The liquid washing and cleaning agents can be colored with suitable coloring agents to improve their aesthetic impression. Selection of preferred coloring agents presents no problem for persons skilled in the art. Preferred coloring agents have high storage stability, are not sensitive to the other ingredients of the agent and to light, and do not have any distinct substantivity to textile fibers, so as not to stain them.

Examples of foam inhibitors that can be used in the liquid washing and cleaning agents are soaps, paraffins or silicone oils, which can optionally be applied to carrier materials. Suitable antiredeposition agents, also known as “soil repellents” include nonionic cellulose ethers such as methylcellulose and methylhydroxypropylcellulose, with 15 to 30% by weight methoxy groups and 1 to 15% by weight hydroxypropyl groups, based in each case on the nonionic cellulose ether, as well as the polymers of phthalic acid and/or terephthalic acid known at the state of the art, or their derivatives, especially polymers of ethylene terephthalates and/or polyethylene glycol terephthalates, or anionically and/or nonionically modified derivates thereof. Of these, the sulfonated derivatives of the phthalic acid and terephthalic acid polymers are particularly preferred.

Optical brighteners (“whiteners”) can be added to the liquid washing and cleaning agents to eliminate graying and yellowing of the surface appearance of the treated textiles. Those substances are absorbed into the fibers. They cause brightening and simulated bleaching, in that the invisible ultraviolet radiation is converted into visible longer-wavelength light, so that the ultraviolet light absorbed from the sunlight is radiated as a weak bluish fluorescence, giving a pure white with the yellow tone of the grayed or yellowed laundry. Suitable compounds are derived, for example, from the substance classes of the 4,4′-diamino-2,2′-stilbenedisulfonic acids (flavonic acids), 4,4′-distyrylbiphenylenes, methylumbelliferones, coumarins, dihydroquinolinones, 1,3-diarylpyrazolines, naphthalic acid imides, benzoxazole, benzisoxazole, and benzimidazole systems, and the pyrene derivatives substituted with heterocycles. The optical brighteners are usually used in ratios between 0.03 and 0.3% by weight, based on the finished agent.

Graying inhibitors have the function of keeping the dirt removed from the fibers suspended, thus preventing redeposition of the dirt. Water-soluble colloids, mostly organic in nature, are suitable for this purpose. Examples include glue, gelatins, salts of ether sulfonic acids of starch or cellulose, or salts of acidic sulfuric acid esters of cellulose or starch. Polyamides containing water-soluble acidic groups are also suitable for this purpose. Furthermore, soluble starch preparations and starch products other than those cited above are usable, such as degraded starch, aldehyde starches, etc. Polyvinylpyrrolidone is also usable. However, cellulose ethers such as carboxymethylcellulose (sodium salt), methylcellulose, hydroxyalkylcellulose, and mixed ethers such as methylhydroxyethylcellulose, methylhydroxy-propylcellulose, methylcarboxymethylcellulose and mixtures thereof in ratios of 0.1 to 5% by weight, based on the agent are also used.

The agents can contain synthetic anti-wrinkle agents because textiles, especially those of rayon, cotton, and mixtures thereof, can tend to wrinkle because the individual fibers are susceptible to bending, kinking, pressing and pinching transverse to the fiber direction. Those agents include, for example, synthetic products based on fatty acids, fatty acid esters, fatty acid amides, fatty acid alkylol esters, fatty acid alkylolamides or fatty alcohols, usually reacted with ethylene oxide, or products based on lecithin or modified phosphoric acid esters.

The liquid washing and cleaning agents can contain antimicrobially active ingredients to combat microorganisms. They are distinguished by their antimicrobial action spectrum and mechanism of action, between bacteriostats and bactericides, fungistats and fungicides, etc. Examples of important substances from these groups include benzalkonium chloride, alkylarylsulfonates, halophenols, and phenylmercuric acetate. The means according to the invention can also avoid those compounds entirely.

The liquid washing and cleaning agents can contain antioxidants to prevent undesirable changes in the agents due to the action of oxygen and to other oxidative processes on the agents and/or the treated textile surfaces. This class of compounds includes, for example, substituted phenols, hydroquinones, pyrocatechols and aromatic amines, as well as organic sulfides, polysulfides, dithiocarbamates, phosphites and phosphonates.

Use of antistatics which are added to the agents can result in increased wearing comfort. Antistatics increase the surface conductivity, making it possible for charges that develop to leak off better. External antistatics are generally substances with at least one hydrophilic molecular ligand and produce a more or less hygroscopic film on the surfaces. These antistatics, most thereof surface-active, can be classified into nitrogen-containing (amines, amides, quaternary ammonium compounds), phosphorus-containing (phosphoric acid esters), and sulfur-containing alkyl sulfonates, alkyl sulfates) antistatics. External antistatics are described, for example, in the patent applications FR 1,156,513, GB 873 214 and GB 839 407. The lauryl (or stearyl) dimethylbenzylammonium chlorides disclosed there are suitable as antistatics for textile structures or as additives to washing agents. They also produce increased suppleness.

Silicone derivatives, for example, can be used in the liquid washing and cleaning agents to improve ability to absorb water and the rewetting ability, and to make pressing of the treated textile structures easier. They also improve the scouring ability of the agents by their foam-inhibiting properties. Examples of preferred silicone derivatives include polydialkyl or alkylaryl siloxanes, in which the alkyl groups have up to five C atoms and are partially or completely fluorinated. Preferred silicones are polydimethylsiloxanes which may optionally be derivatized and are then amino-functional or quaternized, or have Si—OH, Si—H or Si—Cl bonds. The preferred silicones have viscosities in the range between 100 and 100,000 mPas at 25°. The silicones can be used in ratios between 0.2 and 5% by weight, based on the entire agent.

Finally, the liquid washing and cleaning agents can also contain UV absorbers that are absorbed by the textile structures treated and improve the resistance of the fibers to light. Examples of compounds having these desired properties include compounds that act by nonradiative deactivation and derivatives of benzophenone with substituents in the 2- and/or 4-position. Substituted benzotriazoles, acrylates substituted in the 3-position by phenyl (cinnamic acid derivatives), optionally with cyano groups in the 2-position, salicylates, organic nickel complexes, and natural substances such as umbelliferone and the body's own urocanic acid are also suitable.

Substances that complex heavy metals can be used to avoid degradation of certain contents of washing agents catalyzed by the heavy metals. Examples of suitable heavy metal complexing agents are the alkali salts of ethylenediaminetetraacetic acid (EDTA) or nitrilotriacetic acid (NTA) as well as alkali metal salts of anionic polyelectrolytes such as polymaleates and polysulfonates.

The phosphonates are a preferred class of complexing agents. They are contained in preferred liquid washing and cleaning agents at ratios of 0.01 to 2.5% by weight, preferably 0.02 to 2% by weight, and especially preferably from 0.03 to 1.5% by weight. These preferred compounds include, in particular, organophosphonates such as 1-hydroxyethane-1,1-diphosphonic acid (HEDP), amino-tri(methylenephosphonic acid) (ATMP), diethylenetriamine penta(methylenephosphonic acid) (DTPMP or DETPMP) and 2-phosphonobutane-1,2,4-tricarboxylic acid (PBS-AM). Most thereof are used in the form of their ammonium or alkali metal salts.

The aqueous liquid washing and cleaning agents obtained are preferably clear. That is, they have no sediment and are particularly preferably transparent or at least translucent.

The liquid washing and cleaning agents according to the invention can be used to clean textile fabrics.

To produce the liquid washing and cleaning agents with gellan gum as the thickener, gellan gum is first added to water and allowed to swell at 80°. Then a very small proportion of a salt solution, preferably having divalent or trivalent metal cations such as Al³⁺ or Ca⁺, is added. In the next step, the acidic components such as the linear alkylsulfonates, citric acid, boric acid, phosphonic acid, the fatty alcohol ether sulfates, etc., and the nonionic surfactants are added. then a base such as NaOH, KOH, triethanolamine or monoethanolamine is added, followed by the fatty acid, if used. After that the remaining ingredients and the solvent for the aqueous liquid washing and cleaning agent are added to the mixture, and the polyacrylate thickener, if used. Then the pH is adjusted to about 8.5. Finally, the particles to be dispersed are added and distributed homogeneously throughout the aqueous liquid washing and cleaning agent.

Production of the liquid washing and cleaning agent without gellan gum is accomplished by the usual and known methods and processes in which the components are, for instance, simply mixed in stirred kettles. Water, nonaqueous solvents and surfactant(s) are added as convenient, and the other components are added in portions. No separate heating is necessary in production. If it is desired, the temperature of the mixture should not exceed 80° C.

The capsules can, for example, be dispersed so that they are stable in the aqueous liquid washing and cleaning agents. Stably means that the agents are stable at room temperature and at 40° C. over a period of at least 4 weeks and preferably at least 6 weeks without the agent creaming or sedimenting.

### EXAMPLE EMBODIMENTS

### Example 1

### Prevention of Bacterial Adhesion in Simulated Laundering Experiments

Aqueous suspensions of test microorganism with defined microbial density are applied to textile samples of defined sizes and dried. Then the textile microbial carriers are washed in a laboratory-simulated washing program, with the substances being tested added to the wash liquors. After that the concentration of surviving viable microorganisms on the textile microbial carriers is determined. The results are evaluated by comparison with an untreated but contaminated textile sample included as a control, which was washed in the wash liquor without additives. Optionally the microbial carriers can be pretreated with the wash liquor several times before they are contaminated.

The test strains Staphylococcus hominis (DSM 20328) and Corynebacterium amycolatum (DSM 6922) are cultivated for 18-24 hours under aerobic conditions on CaSo agar. The plates with growth are washed off with water. The suspensions are filtered through glass wool and adjusted to 10⁴ CFU/ml. The wash liquors are made up in suitable Erlenmeyer flasks and contain the required concentrations of wash agent and any added active ingredients in a total of 10 ml. The solutions made up in that way are pre-warmed to 30° C. for about 30 minutes.

The prepared pieces of textiles are placed for 15 minutes in an appropriate volume of the prepared test microorganism suspension and then dried for 120 minutes at 37° C. After drying, a microbial content of 10³ CFU/ml should be attained. That is verified by a microbial count.

This is followed by simulation of the actual washing program:
i. addition of 2 of the contaminated microbial carriers to each wash liquor solution at time 0
ii. shaking for 60 minutes (200 rpm, 30° C.)
iii. rinsing four times for ten minutes each with 10 ml of water each time (200 rpm).

Each microbial carrier is shaken in a 10 ml solution on the Vortex mixer for one minutes at 2500 rpm with 2 ml of glass beads. Then the bacterial shaken off are plated on CaSo agar in a dilution series, incubated aerobically at 37° C. for 2-4 days and the number of microorganisms is determined.

Good anti-adhesive action could be demonstrated in the simulated washing experiment for PEG 600, PEG 12,000, a graft copolymer of PEG 6000 and vinyl acetate, and polyurethanes obtainable by reaction of PEG 12,000, DPMA or 1,6-hexanediol, 1,12-octadecanediol and TMXDI; PEG 6000, 1,12 octadecanediol, PrePU 2953 and TMXDI; PEG 600, PEG 6000 and MDI. In these experiments the graft copolymer and the polyurethanes exhibited better action than the free polyethylene glycols. Some of the results are presented in the following tables.

TABLE 1
Inhibition of adhesion by PEG/vinyl acetate
on polyester microbial carriers

| | CFU/cm² | CFU/cm² |
|---|---|---|
| | S. hominis | C. amycolatum |
| Liquid washing agent A | 3.40 | 7.36 |
| Liquid washing agent A + | 1.92 | 0 |
| 10 ppm PEG | | |
| 6000/vinyl acetate | | |
| (65/35) | | |

TABLE 2
Inhibition of adhesion by polyurethane (1 part of
PEG 12,000, 1 part of DPMA, 2.2 parts of Loxanol,
4 parts of TMXDI) on polyester microbial carriers.

| | CFI/cm² | CFU/cm² |
|---|---|---|
| | S. hominis | C. amycolatum |
| Liquid washing agent B | 8.48 | 3.36 |
| Liquid washing agent B + | 4.72 | 2.16 |
| 1% polyurethane | | |

TABLE 3
Inhibition of adhesion by polyurethane (1 part of PEG
12,000, 1 part of 1,6-hexanediol, 2.2 parts of Loxanol,
4 parts of TMXDI) on polyester microbial carriers.

| | CFI/cm² | CFU/cm² |
|---|---|---|
| | S. hominis | C. amycolatum |
| Liquid washing agent A | 7.81 | 4.44 |
| Liquid washing agent A + | 3.58 | 1.07 |
| 1% polyurethane | | |

TABLE 4
Inhibition of adhesion by polyurethane (1 part of PEG
6,000, 1.7 parts of Loxanol, 4 parts of PrePU 2953, 6.1
parts of TMXDI) on polyester microbial carriers.

| | CFI/cm² |
|---|---|
| | S. hominis |
| Liquid washing agent B | 0.72 |
| Liquid washing agent B + | 0.24 |
| 1% polyurethane | |

TABLE 5
Inhibition of adhesion by polyurethane (1 part PEG
6000, 1.7 parts Loxanol, 4 parts PrePU 2953, 6.1
parts TMXDI) on cotton microbial carriers.

| | CFI/cm² | CFU/cm² |
|---|---|---|
| | S. hominis | C. amycolatum |
| Liquid washing agent B | 0.24 | 10 |
| Liquid washing agent B + | 0.16 | 5.92 |
| 1% polyurethane | | |

TABLE 6
Inhibition of adhesion by polyurethane (1 part PEG 600, 0.1
part PEG 6000, 1 part MDI) on polyester microbial carriers.

| | CFI/cm² |
|---|---|
| | S. hominis |
| Liquid washing agent B | 0.72 |
| Liquid washing agent B + | 0.16 |
| 1% polyurethane | |

TABLE 7
Inhibition of adhesion by polyurethane (1 part PEG 600, 0.1
part PEG 6000, 1 part MDI) on cotton microbial carriers.

| | CFI/cm² | CFU/cm² |
|---|---|---|
| | S. hominis | C. amycolatum |
| Liquid washing agent B | 0.24 | 10 |
| Liquid washing agent B + | 0.16 | 6.72 |
| 1% polyurethane | | |

TABLE 8
Inhibition of adhesion by PEG/vinyl acetate on polyester microbial
carriers in a Speckles formulation on polyester microbial carriers.

| | CFI/cm² | CFU/cm² |
|---|---|---|
| | S. hominis | C. amycolatum |
| Liquid washing agent B | 2.06 | 0.58 |
| Liquid washing agent B + | 1.06 | 0.04 |
| 2 ppm PEG 6000/vinyl | | |
| acetate (65/35) | | |

TABLE 9
Inhibition of adhesion by PEG/vinyl acetate in different
ratios on polyester microbial carriers.

| | CFU/cm² |
|---|---|
| | C. amycolatum |
| Liquid washing agent A | 71.05 |
| Liquid washing agent A + 10 ppm PEG 6000/vinyl | 6.82 |
| acetate (90/10) | |
| Liquid washing agent A + 10 ppm PEG 6000/vinyl | 5.68 |
| acetate (80/20) | |
| Liquid washing agent A + 10 ppm PEG 6000/vinyl | 20.23 |
| acetate (70/30) | |
| Liquid washing agent A + 10 ppm PEG 6000/vinyl | 27.82 |
| acetate(60/40) | |
| Liquid washing agent A + 10 ppm PEG 6000/vinyl | 97.93 |
| acetate (50/50) | |

### Example 2

### Prevention of Bacterial Adhesion in Wash/Wear Experiments

The antiadhesive action of polyurethanes on bacterial adhesion to textiles was investigated in a study with subjects. Five subjects wore polyester T-shirts once a week for 5 weeks. After wearing, the T-shirts were washed with liquid washing agent B. 1% of a polyurethane (1 part PEG 12,000, 1 part DPMA, 2.2 parts Loxanol, 4 parts TMXDI) was added to the washing agent for analysis of the antiadhesive activity. After the wash-wear cycles, replicate plates were made at 3 different positions on the insides of the T-shirts, and the numbers of microbes found were compared.

TABLE 10
Average microbial content on the insides
of T-shirts worn and washed five times.

| | CFU/cm² |
|---|---|
| Liquid washing agent B | 1.38 |
| Liquid washing agent B + | 0.66 |
| 1% polyurethane | |

### Example 3

### Production of Alginate Capsules

Various capsules, K1 to K6, with alginate as the matrix material, were made or dispersed as droplets in a hardening bath with a Rieter drop-making system.

The different alginate solutions had the compositions shown in Table 11 (compositions in percent by weight).

TABLE 1

| | K1 | K2 | K3 | K4 | K5 | K6 |
|---|---|---|---|---|---|---|
| Sodium alginate | 1 | 1 | 1 | 1 | 1 | 1 |
| Aerosil 200 | 3 | 3 | 3 | — | — | — |
| Sipernat 22S | — | — | — | 3 | 3 | 3 |
| Hollow microbeads¹ | 2 | 2 | 2 | 2 | 2 | 2 |
| Preservative | 0.05 | 0.05 | 0.05 | 0.05 | 0.05 | 0.05 |
| Coloring agent | 0.1 | 0.1 | 0.1 | 0.1 | 0.1 | 0.1 |
| Antiadhesives: | | | | | | |
| Polymer | 5 | 15 | 25 | 5 | 15 | 25 |
| Water | To | To | To | To | To | To |
| | make 100 | make 100 | make 100 | make 100 | make 100 | make 100 |

¹Hollow ceramic microbeads with diameters in the range of 10 to 125 μm and densities n the range of 0.5 to 0.7 g · cm⁻³.

The hardening bath used contained:

a. 2.5% by weight CaCl₂

b. 0.2% by weight polyallyldimethylammonium chloride

c. 0.05% by weight preservative and water to make 100%.

The capsules obtained, K1 to K6, were washed repeatedly with water and a complexing agent such as Dequest®.

The capsules according to the invention can be dispersed stably in aqueous liquid washing and cleaning agents of quite different composition. ‘Stably’ means that the agent is stable for a period of at least 4 weeks and preferably 6 weeks at room

Table 12 shows washing and cleaning agents E1 to E4 according to the invention. The washing and cleaning agents E1 to E4 have viscosities of about 1,000 mPas. The liquid washing and cleaning agents had a pH of 8.5.

TABLE 12

| | E1 | E2 | E3 | E4 |
|---|---|---|---|---|
| Gellan gum | 0.2 | 0.2 | 0.15 | — |
| Xanthan gum | — | — | 0.15 | — |
| Polyacrylate (Carbopol Aqua 30) | 0.4 | 0.4 | — | 0.6 |
| C₁₂₋₁₄ fatty alcohol with 7 EO | 22 | 10 | 10 | 10 |
| C₉₋₁₃ alkylbenzenesulfonate, | — | 10 | 10 | 10 |
| sodium salt | | | | |
| C₁₂₋₁₄ alkyl polyglycoside | 1 | — | — | — |
| Citric acid | 1.6 | 3 | 3 | 3 |
| Phosphonic acid | 0.5 | 1 | 1 | 1 |
| Sodium lauryl ether sulfate with | 10 | 5 | 5 | — |
| 3 EO | | | | |
| Monoethanolamine | 3 | 3 | 3 | — |
| C₁₂₋₁₈ fatty acid | 7.5 | 7.5 | 7.5 | 5 |
| Propylene glycol | — | 6.5 | 6.5 | — |
| Sodium cumenesulfonate | — | 2 | 2 | — |
| Boric acid | — | — | — | 1 |
| Enzymes, coloring agents, | + | + | + | + |
| stabilizers | | | | |
| Capsules K1 with diameters | 0.5 | 0.5 | 0.5 | 0.5 |
| about 2000 μm | | | | |
| Water | To | To | To | To |
| | make | make | make | make |
| | 100 | 100 | 100 | 100 |

1-27. (canceled)

28. A method comprising:
(a) providing a textile substrate;
(b) contacting the substrate with a polymer such that adhesion of a microorganism to the substrate is reduced.

29. The method according to claim 28, wherein the polymer comprises a polymeric structural element selected from the group consisting of polyesters, polysaccharides, polyethers, polyurethanes, polyureas, polyamides, and heteropolymers thereof.

30. The method according to claim 28, wherein the polymer comprises a polymeric structural element selected from the group consisting water-soluble polyethylene glycols and copolymers of ethylene glycol and propylene glycol having a molecular weight of about 100 to about 50,000 g/mole.

31. The method according to claim 29, wherein the polymer comprises a graft copolymer and the polymeric structural element represents a graft base of the graft copolymer.

32. The method according to claim 31, wherein the graft copolymer comprises graft branches obtained by reacting an ester of an unsaturated C₁₋₆ alcohol with linear or branched saturated monocarboxylic acids having 2 to 24 C atoms.

33. The method according to claim 30, wherein the polymer comprises a polyurethane having the polymeric structural element incorporated therein.

34. The method according to claim 33, wherein the polymeric structural element is incorporated into the polyurethane with a diisocyanate.

35. The method according to claim 34, wherein the polyurethane further comprises a short-chain, non-polymeric diol monomer.

36. The method according to claim 28, wherein the polymer comprises a polyurethane prepared by a process comprising: reacting (i) a diisocyanate, (ii) a polyethylene glycol having a molecular weight of about 11,000 to 13,000 g/mole, (iii) a diol having 16 to 20 C atoms, and (iv) a diol having 4 to 8 C atoms; in a ratio of about 4:1:2.2:1.

37. The method according to claim 28, wherein the polymer comprises a polyurethane prepared by a process comprising: reacting (i) a diisocyanate, (ii) a polyethylene glycol having a molecular weight of about 5,000 to 7,000 g/mole, (iii) a diol having 16 to 20 C atoms, and (iv) a prePU having a molecular weight of 2,500 to 3,500 g/mole; in a ratio of about 6.1:1:1.7:4.

38. The method according to claim 28, wherein the polymer comprises a polyurethane prepared by a process comprising: reacting (i) a diisocyanate, (ii) a polyethylene glycol having a molecular weight of about 5,000 to 7,000 g/mole, and (iii) a polyethylene glycol having a molecular weight of about 500 to 700 g/mole; in a ratio of about 1:0.1:1.

39. The method according to claim 28, wherein the polymer comprises a graft copolymer prepared by a process comprising: grafting a polyethylene glycol having a molecular weight of about 5,000 to 7,000 g/mole with an ester of a C₂₋₆ enol and a C₂₋₄ carboxylic acid, wherein a ratio of percentages by weight of polyethylene glycol to ester is 50:50 to 199:1 in the grafting mixture.

40. A capsule comprising a polymer having antiadhesive action against microorganisms which adhere to a textile substrate.

41. The capsule according to claim 40, wherein the capsule has a polymeric matrix structure.

42. The capsule according to claim 41, wherein the polymeric matrix structure comprises a matrix material selected from the group consisting of alginate, carrageenan, gellan gum and mixtures thereof.

43. The capsule according to claim 40, wherein the polymer comprises a polymeric structural element selected from the group consisting water-soluble polyethylene glycols and copolymers of ethylene glycol and propylene glycol having a molecular weight of about 100 to about 50,000 g/mole.

44. The capsule according to claim 43, wherein the polymer comprises a polyurethane having the polymeric structural element incorporated therein.

45. The capsule according to claim 44, wherein the polymeric structural element is incorporated into the polyurethane with a diisocyanate.

46. The capsule according to claim 45, wherein the polyurethane further comprises a short-chain, non-polymeric diol monomer.

47. A textile treatment agent comprising a polymer having antiadhesive action against microorganisms which adhere to a textile substrate.

48. A textile substrate treated with a textile treatment agent according to claim 47.
